(19) United States
(12) Patent Application Publication
(10) Pub. No.: US 2002/0176800 A1
(43) Pub. Date: Nov. 28, 2002

(54) Curved miniature liquid chromatography column

(76) Inventors: Richard A. Henry, State College, PA (US); Chia-Hui Paul Shieh, Fremont, CA (US)

Correspondence Address: Pamela A. Ruest, Esq., McQuaide Blasko, 811 University Drive, State College, PA, 16801-6699, US

(21) Appl. No.: 10/142,415

(22) Filed: May 9, 2002

Related U.S. Application Data
(60) Provisional application No. 60/289,743, filed on May 9, 2001.

(51) Int. Cl. G01N 23/06

(52) U.S. Cl. 422/71

(57) ABSTRACT

A packed miniature liquid chromatography column having a curved or a coiled configuration for direct coupling to liquid chromatographic equipment is disclosed. The column may be encased by a housing for protection during handling and use.

### RELATED APPLICATIONS

This application claims priority to U.S. Provisional Patent Application No. 60/289,743 filed May 9, 2001.

### FIELD OF THE INVENTION

The present invention relates to miniature analytical columns for liquid chromatographic separations and more particularly to columns having a curved or a coiled configuration for use in liquid chromatographic systems.

### BACKGROUND OF THE INVENTION

In a liquid chromatographic system or a total solution liquid chromatographic system, the liquid chromatography (“LC”) column is located between an injector and a detector to separate one or more constituents of interest from the various interferences in a sample to be analyzed and to permit detection of these constituents by the detector. A typical detector in a liquid chromatographic system can measure and provide an output in terms of mass per unit of volume or mass per unit of time of the sample's components. From such an output signal, a “chromatogram” can be provided. The chromatogram can then be used by an operator to accurately identify and quantitate the chemical components present in the sample.

A trend in chromatography has been to move to higher performance and miniature liquid chromatography columns. The reason for the strong recent trend toward miniaturization is that miniaturized liquid chromatography columns have extremely low solvent consumption and require drastically reduced volumes of sample for analysis, hence providing high efficiency, sensitive separations when samples are limited. In liquid chromatography, high resolution has been obtained using narrow diameter microparticle packed columns. A miniature microparticle packed liquid chromatography column is typically manufactured by packing a narrow diameter tube uniformly with separation media such as bonded silica particles, also referred to as packing material.

Materials commonly used for the preparation of miniature analytical columns include polymer, glass, metal, fused silica and its subgroups polymer-coated fused silica and polymer-clad fused silica. Representative metals typically include stainless steel and glass-lined stainless steel.

Miniature liquid chromatography columns include small bore, microbore and capillary columns. These columns typically have lengths ranging from about 5 mm to 300 mm, but in some instances they may approach lengths of up to 5000 mm. Small bore columns generally have inner diameters of about 2 mm, whereas microbore columns have diameters of approximately 1 mm. Fused silica and other capillary columns typically have inner diameters of less than 1 mm and often less than 0.1 mm. In fact, capillary columns having inner diameters of 0.075 mm have almost become standard for liquid chromatography mass spectrometry. Fused silica capillary columns can withstand high packing pressure, e.g., 9000 psi or greater.

Although fused silica liquid chromatography columns have several distinct advantages, they do have certain limitations. One such limitation stems from the fragile nature of the fused silica tube that can make packing, shipping and handling difficult, especially if any part of the fused silica is unprotected by a coating. For instance, the columns can be broken by laboratory employees prior to or during installation in liquid chromatography equipment despite the exercise of ordinary care.

Another problem overshadowing the advantages of liquid chromatography columns has been the historic teaching that the bending or coiling of packed high performance liquid chromatography (“HPLC”) columns would diminish column efficiency. Gas chromatography (“GC”) columns, both packed and open tubular, have been bent and coiled for many years due to faster mass transfer capabilities and lower efficiency per unit length under gaseous mobile phase conditions. The primary reason for bending and coiling gas chromatography columns has been to consolidate the required longer lengths into small spaces for convenient shipping and temperature control, rather than to enhance performance.

While packed gas chromatography columns have been commonly fabricated in coil and “U-shapes,” it is generally accepted that bed integrity and uniformity are not extremely critical to performance in packed column gas chromatography. This is primarily due to the fact that fast axial diffusion occurs across gaseous flow paths or channels between particles even if paths are moving at different linear velocities. This has the effect of keeping the multipath or A-term of the Van Deemter equation relatively constant even when the bed is disturbed. In fact, packed gas chromatography columns tend to perform well even in cases where gaps or voids are observed within a packed bed. This characteristic has not been observed under liquid chromatographic conditions. Bed uniformity in packed liquid chromatography columns is extremely critical due to the presence of small particles, high efficiency per unit length and slow axial diffusion across flow channels.

It is also common for fused silica columns used in capillary electrophoresis (“CE”) to be employed in a bent configuration. This, however, is done for convenience (i.e. to fit a particular instrument design), not to enhance overall performance. Columns may be bent and coiled in capillary electrophoresis, as in open tubular gas chromatography, because there are no particles or packed beds to be concerned with, and the A-Term of the Van Deemter equation does not apply. In both cases of open tubular separation, one involving a gaseous moving phase and the other a liquid moving phase, columns may be used efficiently in non-linear configurations without any significant loss of performance.

Packed fused silica columns having small inner diameters have been used in connection with capillary electrokinetic chromatography (“CEC”), where high performance is attributed to plug flow created by electro-osmotic forces that generate flow at all points along the column. It is a widely held belief that capillary electrokinetic chromatography columns perform well in both straight and bent configurations because of the unusual plug flow that makes bed uniformity much less critical than it is in the pressure-driven flow of liquid chromatography. In addition, there is no multi-path term to account for because flow is generated independently in each flow channel by the action of surface charges on column walls and particles combined with the effects of high voltage. Even though the multi-path term is critical to acceptable liquid chromatography performance under pressure-driven flow as predicted by theory, the present inventors have discovered that the beds of capillary columns filled with small particles are much more resistant to disturbance by bending or coiling than previously thought or taught.

Even with miniaturization in liquid chromatography, the standard practice is still to fabricate analytical columns in short straight lengths of tubing, the only accepted column configuration. This poses some significant connection problems, as miniature column systems are developed to separate highly complex mixtures with very small sample sizes. For instance, multidimensional liquid chromatography trace analysis requires that multiple miniature analytical and guard columns of various lengths and inner diameters ranging from less than 0.1 mm to 1 mm be interfaced to valve bodies and other manifolds of liquid chromatographic equipment so that efficient stream switching can be employed to guide the sample through the separation scheme.

One example of this is where a strong cation exchange (“SCX”) column of analytical dimensions is used in conjunction with two guard or trap columns, and with a second reversed phase (“RP”) analytical column for resolving a protein tryptic digest. Complex samples can be pre-fractionated on the SCX column, collected on the trap columns, and washed into the reversed phase column for final resolution, detection and identification by a mass spectrometer. The bed dimensions of guard and trap columns are typically very short (5-50 mm) since they are primarily used to protect, collect and focus. In contrast, bed dimensions of analytical columns are typically much longer (50-250 mm) because they are used to separate. Separation or resolving power of a column is directly proportional to the square root of the number of theoretical plates, which in turn is directly proportional to length.

Although miniature bore analytical columns exhibit more concentrated sample zones and allow higher mass sensitivities than larger bore columns, their overall performance in separation has been diminished by the dispersion that occurs in connective tubing and end-fitting assemblies as the inside diameter and volume of columns decrease in size. Such tubing and fittings generate unnecessary extra-column volume which degrades separation efficiency. One of the pioneers in the gas and liquid chromatography field, in describing the extra-column effects associated with small bore liquid chromatography columns, declared “it is obvious that the ideal situation . . . is where the chromatographic column is directly connected to the injection device and to the detector . . . ; however, this can present certain experimental difficulties, and therefore connecting tubes are often used . . . ” R. P. W. Scott, Small Bore Liquid Chromatography Columns: Their Properties and Uses 41 (John Wiley & Sons, 1984). Scott has also commented that “one of the disadvantages of the use of small bore columns that arises from their small dimensions is that specially designed chromatographic equipment having low dispersion is required to fully realize all potential advantages that they might provide in practical applications.” Scott, supra, at 52.

Recent developments involving miniature chromatographic columns include: U.S. Pat. No. 5,938,919 to Najafabadi; U.S. Pat. No. 4,293,415 to Bente; U.S. Pat. No. 5,908,552 to Dittmann et al.; U.S. Pat. No. 5,646,048 to Templin et al.; U.S. Pat. No. 4,483,773 to Yang; and U.S. Pat. No. 5,651,885 to Schick.

Najafabadi discloses a fused silica capillary column protected by a flexible shield of polymer tubing. Bente describes a silica chromatographic column made from drawn silica tubing having an exterior coating for protection from abrasion. The column described by Bente is an open tubular column primarily used for gas chromatography. Dittmann et al. show a packed, non-curved column for capillary chromatographic separations having an external coating. Templin et al. describe a microcolumnar analytical apparatus containing a curved section comprising an outer tubing piece. However, Templin's device contains two columns inside the tube, essentially the equivalent of connective tubing. Yang describes a process for packing a capillary column in order to achieve high column efficiency. Schick discloses a straight, packed biocompatible column having an outer metallic tube for use in a liquid chromatographic separation. None of the art, however, discloses a curved or coiled packed analytical column for specific use in liquid chromatographic separations.

Until recently, straight columns having lengths of approximately 25 cm or less and containing particles approximately 5 μm in diameter have been convenient and adequate for most purposes. Where necessary, columns have been coupled with appropriate capillary tubing in order to increase their lengths. Recently, however, it has become desirable to employ packed high performance liquid chromatography columns having small inner diameters in very restricted places with minimal or no connection volume.

There is a need, therefore, for an improved, packed miniature liquid chromatography column that can enhance the performance of the liquid chromatographic system.

### SUMMARY OF THE INVENTION

Most separations to date have been carried out on straight columns having end-fittings that contain frits, screens and other metallic and nonmetallic filter elements designed to hold loose packing particles inside the analytical column. Columns made in this manner often require excessive connector volume for installation into a liquid chromatographic system. However, the present invention advantageously provides miniature packed analytical columns having curved, single-coiled and multiple-coiled configurations that enable direct and efficient connection to a liquid chromatographic system and eliminate the need for excessive connector tubing and end-fittings. Since the columns can be installed closely or directly at the connection port rather than oblique to it, dispersive band spreading is diminished, while resolution and sensitivity in trace analysis is enhanced. Additionally, excessive handling and flexing of the nonlinear liquid chromatography columns during installation and use is avoided.

The curved and coiled columns may in certain preferred embodiments of the invention be adapted for direct connection to a sleeve device having an integral filter element that encloses an opening at a first end of the miniature analytical column, an opening at a second opposing end of the column or the openings at both ends of the column. The sleeve with integral filter element, also referred to as a fritted sealing sleeve, retains the immobilized packing material without the need for an end-fitting as in the prior art.

In certain preferred embodiments of the invention, a housing may be employed as shielding for the miniature curved or coiled column to form a shielded analytical column. The housing protects the column from the various handling conditions that the column is subject to as well as the typical operating pressures of the liquid chromatographic system. Preferably, the housing substantially encases the nonlinear liquid chromatography column while allowing the ends of the column to protrude through the housing.

Accordingly, it is an object of the present invention to provide a packed miniature analytical column having a curved or a coiled configuration that can be directly coupled to a valve or other device in a liquid chromatographic system.

An additional object of the invention is to provide a curved or coiled liquid chromatography column that achieves higher resolution separations by avoiding the use of connector tubing and end-fitting assemblies.

A further object of the present invention is to provide a housing that protects the fragile analytical column from breakage during handling and during operation of the liquid chromatographic system.

It is a further object of the invention to provide a liquid chromatography column having a housing that facilitates easy labeling and environmental control of the column.

### BRIEF DESCRIPTION OF THE DRAWINGS

FIG. 1 depicts a curved packed analytical column having a sealing mechanism.

FIGS. 2a and 2b illustrate a single-coil packed analytical column having a sealing mechanism and having ends oriented in different directions.

FIG. 3 is a multiple-coil packed analytical column with a sealing mechanism. The column further employs a union body containing a filter element and a connection assembly to effect installation into a fitting manifold.

FIG. 4a is a sealing sleeve with an integral filter element that slips over the end of connective tubing or the end of a packed analytical column to create a column or filtering connector that can be installed directly in the seat of a valve or other fitting manifold.

FIG. 4b shows a multiple-coil packed analytical column adapted for direct connection to a fitting manifold. The exploded view shows the column prior to insertion into the sealing sleeve with imbedded filter element and prior to insertion into a compression nut and ferrule.

FIG. 5 depicts a valve assembly with associated connection ports having two curved packed analytical columns, which employ a fritted sealing sleeve, installed directly and efficiently without connectors, thereby minimizing dispersion.

FIG. 6 illustrates two methods of connecting a miniature bore column to a valve port.

FIG. 7 is a chromatographic efficiency test showing no loss of performance when a 100 mm by 0.18 mm inner diameter fused silica column is tested in a straight configuration, then bent into a U-shape, and then completely coiled to a diameter of 2 cm.

FIG. 8a illustrates a curved miniature bore chromatographic column having a tubular housing that protects the column and also serves to maintain the column in a curved configuration. The tubular housing also has a label affixed to its outer surface.

FIG. 8b is an easily removable base and cover housing that maintains the configuration of the multiple-coil column.

FIGS. 8c and 8d depict a packed single-coil column retained in a single-piece housing.

FIG. 9 illustrates the use of columns in a two-dimensional (“2-D”) LC-MS system for trace analysis of complex biological mixtures.

FIG. 10 is a chromatographic analysis of a protein tryptic digest obtained with curved columns.

### DETAILED DESCRIPTION OF THE INVENTION

The present invention describes a packed, miniature liquid chromatography column, suitable for use in a separation process, wherein the column has a curved 10, single-coil 16 or multiple-coil 17 configuration.

The curved column 10, illustrated in FIG. 1, comprises an analytical column 10 having an inner diameter in the range of approximately 0.05 mm to 2 mm and a length between approximately 25 mm and 300 mm. The column 10, however, can be fabricated in lengths of up to 5000 mm. A column having a length of 25 mm or less can also be fabricated in a curved configuration by only partially filling the column with particles.

The curved column 10 is a substantially hollow, cylindrical tube defining an internal cavity and having openings at first and second ends 11, 12 of the tube as well as a packing material disposed therein. Although the tube shown is substantially oriented in a U-shape, other column configurations such as ellipses may be employed.

A sealing mechanism 13, comprising a substantially hollow cylindrical sealing sleeve 14, a compression nut 22 and a ferrule 23 encloses the opening at one or both ends 11, 12 of the curved column 10. However, any commonly used sealing means may be employed. The ferrule 23 secures and seals the column 10 to the other components of the sealing mechanism 13 as the compression nut 22 is threaded and tightened. The packed column 10 may be enclosed by the sealing mechanism 13 at one end or at both ends 11, 12.

The curved column 10 can be closely coupled to a valve 18 by employing a minimal amount of connective tubing 15 at each end 11, 12 of the column 10, wherein the tubing 15 is preferably less than the length of the column 10. The need for connective tubing 15 may be eliminated entirely by utilizing a curved column 10 having filter elements embedded inside the bore, by employing monolithic column technology or by utilizing the fritted sealing sleeve 33 shown in FIG. 4.

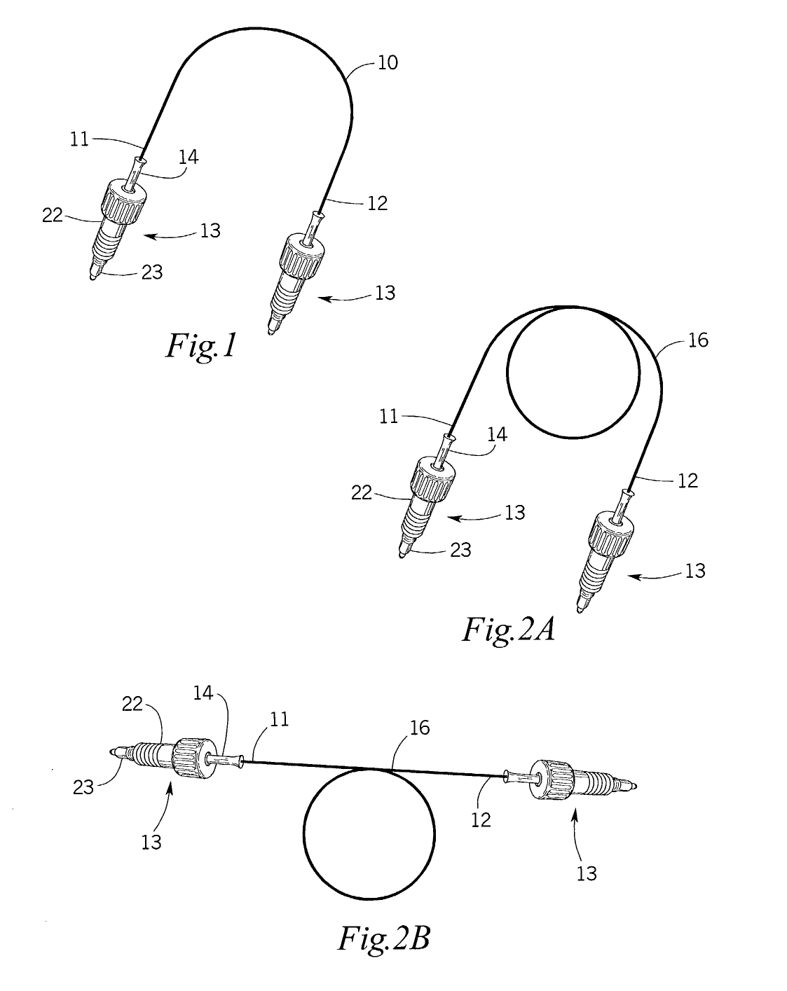

The single-coil column, illustrated in FIG. 2, comprises an analytical column 16 having an inner diameter in the range of approximately 0.05 mm to 2 mm and a length between approximately 25 mm and 300 mm. The column 16, however, can be fabricated in lengths of up to 5000 mm. A column having a length of 25 mm or less can also be fabricated in a coiled configuration by only partially filling the column with particles.

The single-coil column 16 is a substantially hollow, cylindrical tube defining an internal cavity and having openings at first and second ends 11, 12 of the tube as well as a packing material disposed therein. A segment of the cylindrical tube comprises a single loop. The cylindrical tube shown in FIG. 2 is substantially oriented in a U-shape, and a single loop is situated within the U. In this embodiment, the ends 11, 12 of the column 16 are substantially parallel. In FIG. 2b, however, the ends 11, 12 of the single-coil column 16 are oriented at a 180° angle. These embodiments are merely illustrative. The ends 11, 12 of the single-coil column 16 may be advantageously oriented in any position that allows for convenient and efficient installation into a liquid chromatographic system, irrespective of the length of the column 16.

A sealing mechanism 13, comprising a substantially hollow cylindrical sealing sleeve 14, a compression nut 22 and a ferrule 23 encloses the opening at one or both ends 11, 12 of the single-coil column 16. However, any commonly used sealing means may be employed. The ferrule 23 secures and seals the column 16 to the other components of the sealing mechanism 13 as the compression nut 22 is threaded and tightened. The packed column 16 may be enclosed by the sealing mechanism 13 at one end or at both ends 11, 12.

The single-coil column 16 can be closely coupled to a valve 18 by employing a minimal amount of connective tubing 15 at each end 11, 12 of the column 16, wherein the tubing 15 is preferably less than the length of the column 16. The need for connective tubing 15 may be eliminated entirely by utilizing a single-coil column 16 having filter elements embedded inside the bore, by employing monolithic column technology or by utilizing the fritted sealing sleeve 33 shown in FIG. 4. The single-coil column 16 is advantageous for introducing a variety of bed lengths between two fixed positions such as an injector, a detector, a valve or other device.

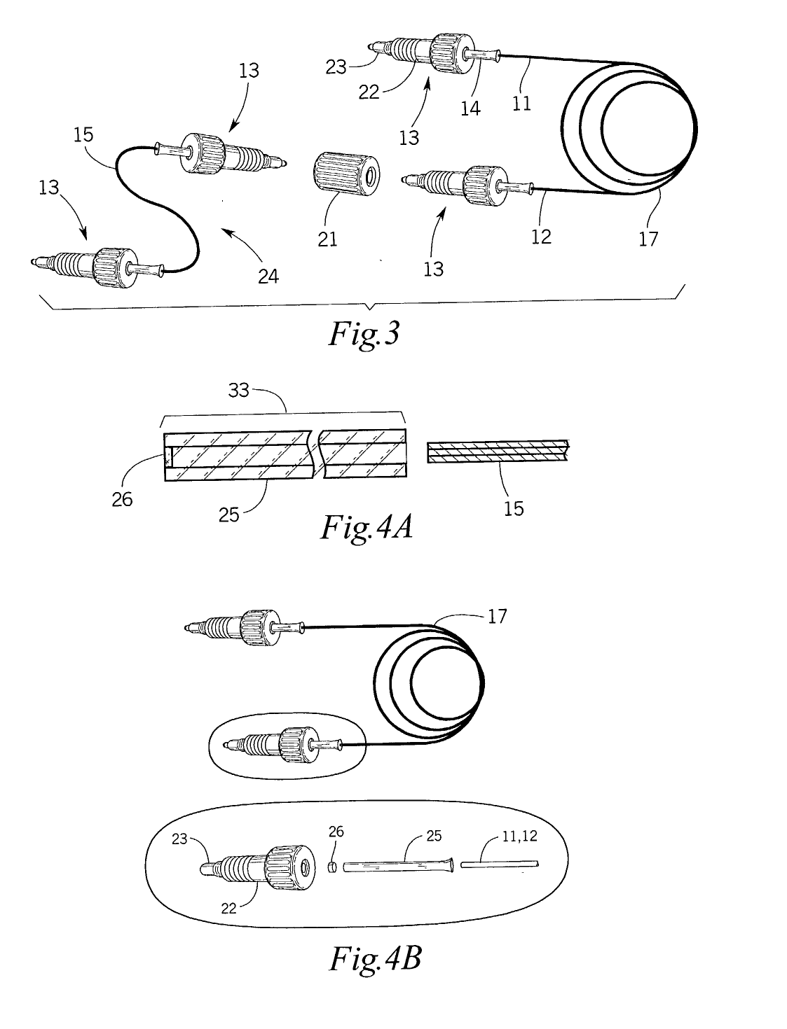

The multiple-coil column, illustrated in FIG. 3, comprises an analytical column 17 having an inner diameter in the range of approximately 0.05 mm to 2 mm and a length between approximately 25 mm and 300 mm. The column 17, however, can be fabricated in lengths of up to 5000 mm. A column having a length of 25 mm or less can also be fabricated in a coiled configuration by only partially filling the column with particles.

The multiple-coil column 17 is a substantially hollow, cylindrical tube defining an internal cavity and having openings at first and second ends 11, 12 of the tube as well as a packing material disposed therein. A segment of the cylindrical tube comprises two or more loops. The cylindrical tube shown in FIG. 3 is substantially oriented in a U-shape, and three loops are situated within the U. In this embodiment, the ends 11, 12 of the column 17 are substantially parallel. The ends 11, 12, however, may be advantageously oriented in any position that allows for convenient and efficient installation into a liquid chromatographic system, irrespective of the length of the column 17.

A sealing mechanism 13, comprising a substantially hollow cylindrical sealing sleeve 14, a compression nut 22 and a ferrule 23 encloses the opening at one or both ends 11, 12 of the multiple-coil column 17. However, any commonly used sealing means may be employed. The ferrule 23 secures and seals the column 17 to the other components of the sealing mechanism 13 as the compression nut 22 is threaded and tightened. The packed column 17 may be enclosed by the sealing mechanism 13 at one end or at both ends 11, 12.

The multiple-coil column 17 depicted in FIG. 3 can be closely coupled to a valve 18 by employing a minimal amount of connective tubing 15 at each end 11, 12 of the column 17, wherein the tubing 15 is preferably less than the length of the column 17. The need for connective tubing 15 may be eliminated entirely by utilizing a multiple-coil column 17 having filter elements embedded inside the bore, by employing monolithic column technology or by utilizing the fritted sealing sleeve 33 shown in FIG. 4. The multiple-coil column is advantageous for introducing a wide variety of bed lengths between two fixed positions such as an injector, a detector, a valve or other device.

A short liquid chromatography column, defined herein as a column having a length of approximately 50 mm or less, can be coupled to longer columns as part of a larger bent or coiled assembly. For instance, a fully packed analytical column having a bent 10 or a coiled 16, 17 configuration can be used in conjunction with a short, straight guard column.

The distance between the ends 11, 12 of the curved 10, single-coil 16 and multiple-coil 17 columns when in the installation position is typically much less than the overall column length. For instance, in a preferred embodiment of the invention, the distance between the ends 11, 12 of the columns 10, 16, 17 is less than about seventy percent (70%) of the lengths of the columns 10, 16, 17. In an even more preferred embodiment of the invention, the distance between the ends 11, 12 of the columns 10, 16, 17 is less than about sixty-four percent (64%) of the lengths of the columns 10, 16, 17. In a most preferred embodiment of the invention, the distance between the ends 11, 12 of the columns 10, 16, 17 is less than about fifty percent (50%) of the lengths of the columns 10, 16, 17.

FIG. 6 illustrates two methods for connecting a small bore column to a valve 18 or other manifold of a liquid chromatographic system. FIG. 6a shows the current widely accepted method of connecting a straight packed column 19 to a valve port 20 by employing short lengths of intermediate connecting tubing 15. FIG. 6b, on the other hand, illustrates a preferred method of connecting a packed column directly to the valve port 20 using the curved packed column 10 of the present invention, thereby minimizing dispersion and enhancing performance measured by higher efficiency and lower detection limits. It should noted, however, that many of the advantages associated with the use of coiled 16, 17 and bent 10 columns can also be realized using short lengths of connective tubing 15 as an alternative to direct connection.

The traditional means of connecting a packed column to a valve 18 (FIG. 6) or other device utilizes a union body 21, also referred to as an end-fitting, containing a filter element (FIG. 3) to hold the packing in place in conjunction with the sealing mechanism 13. In the present invention, use of the union 21 may be avoided by employing a fritted sealing sleeve 33 in connection with a traditional nut 22 and ferrule 23 (see FIG. 4). FIG. 3 illustrates a multiple-coil packed capillary analytical column 17 that employs the union 21 as an end-fitting. The filter element allows packing solvent to pass through while retaining the packing material inside the capillary column 17.

When an extra end-fitting 21 is needed to hold the filter element and contain the packing, a connection assembly 24, depicted in FIG. 3, may be employed to allow sample to pass through the system for analysis. When liquid chromatography columns are large (typically ⅛ inch or ¼ inch outer diameter), the union body 21 serves as a reducing adapter to facilitate the connection of capillary tubing 15 having outer diameters as small as 1/16 inch, 1/32 inch or smaller. Because capillary columns are small, much like connection tubing 15, it is desirable to eliminate the union 21 so that the columns can be connected directly to valves 18 (FIG. 6) or other devices.

In order to fully realize the advantages of curved 10 and coiled 16, 17 analytical and guard columns, a means of directly coupling the columns 10, 16, 17 to a valve body 18 (FIG. 6) or other fitting manifold is desirable. A fritted sealing sleeve 33 (FIG. 4) was developed for this purpose. The sleeve member 25, shown in FIG. 4a is a substantially hollow, cylindrical tube, having a first end and a second end, with a filter element 26 embedded at one end of the tube. The filter element 26 is a screen that allows packing solvent, but not packing material to pass through during the packing process. A frit may also be used in place of the screen. In either case, the filter element 26 can be integrated into the cylindrical tube by a heat setting technique. The sleeve member 25 is desirably made of an inert polymer tubing such as polyetheretherketone (“PEEK”), polyimide or fluorocarbon. The screen and frit desirably comprise a disc shape and are made of an inert material such as stainless steel.

A capillary with a fritted sealing sleeve 33 can be used to prepare a packed column or it can be used as a filtering element when incorporated into empty capillary connecting tubing 15. Sealing one or both ends 11, 12 of a column with the fritted sealing sleeve 33 enables the ends 11, 12 of the column to be directly coupled to a fitting manifold. Advantageously, the fritted sealing sleeve 33, when used alone, can also extend the lifetime of guard columns as well as analytical columns by providing additional upstream protection from particles.

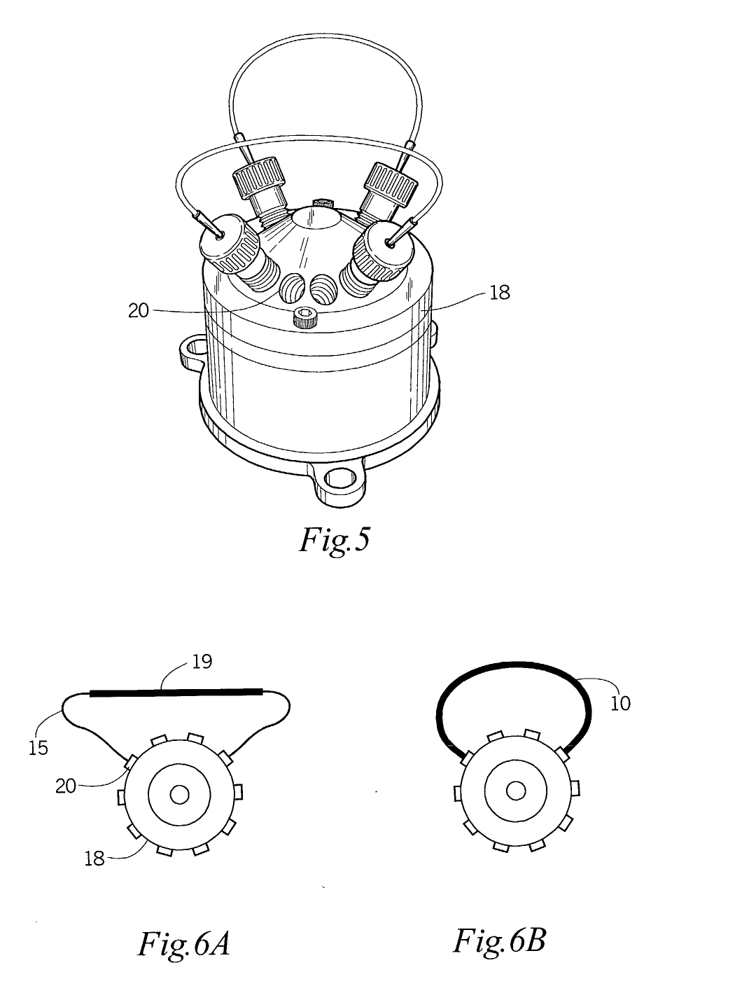

FIG. 4b illustrates a multiple-coil packed capillary analytical column 17 adapted for direct connection to a fitting manifold. The exploded view shows that the sleeve member 25 is conveniently fitted over an end 11,12 of the column 17 (or capillary tubing 15, FIG. 4a), with the inner wall of the sleeve member 25 forming a cavity slightly larger than the column 17 and being spaced close to the external surface of the column 17. The space between the exterior surface of the column 17 and the interior surface of the sleeve member 25 is preferably as small as possible, while still allowing the sleeve member 25 to be fitted over the column end 11,12. The fritted sealing sleeve 33 (FIG. 4a) and sleeve-covered column can then be inserted into a compression nut 22 and ferrule 23 prior to insertion into a valve assembly 18 (FIG. 5) or other device. In addition to providing an alternative to a conventional end-fitting 21 (FIG. 3), the sleeve with integral filter element 33 can be used in connection with a straight packed liquid chromatography column (FIG. 6a).

A curved 10 or coiled 16, 17 column that employs the sleeve with integrated filter element 33 illustrated in FIG. 4 should be fabricated in appropriately small dimensions. For instance, a sleeve member 25 having an outer diameter of approximately 0.75 mm and an inner diameter of approximately 0.4 mm could be used in connection with a column 10, 16, 17 having an outer diameter of about 0.35 mm to 0.375 mm and an inner diameter of 0.18 mm. In such case, a valve port 20 (FIG. 5), a compression nut 22 or a ferrule 23 designed for connector tubing 15 having an outer diameter of 0.75 mm could be utilized, although other small sizes could be effectively employed.

The curved 10 and coiled columns 16, 17 can also be partially or completely manufactured in a monolithic bed fashion rather than with loose particles so that no separate frit, screen or other filter element is required to retain the packing.

The columns 10, 16, 17 can be fabricated from any material that is inert and capable of being formed into a U, loop or similar shape, in the requisite narrow diameters. The materials should preferably have smooth inner surfaces and even more preferably should not exhibit undesirable wall effects. Preferred materials include polymer, glass, metal, fused silica and its subgroups polymer-coated fused silica and polymer-clad fused silica. Desirable metals that have been found to perform well in liquid chromatography include stainless steel and glass-lined stainless steel. Preferably, the polymer comprises commercially available PEEK or other material having similar flexural and tensile strength.

When packed liquid chromatography columns are lined with or made of fused silica or PEEK, the columns can be bent and even tightly coiled without disturbing the particle bed or changing the flow profile within the column. This finding contradicts the prevailing view that the bending or coiling of a packed liquid chromatography column destroys separation performance by disturbing bed uniformity.

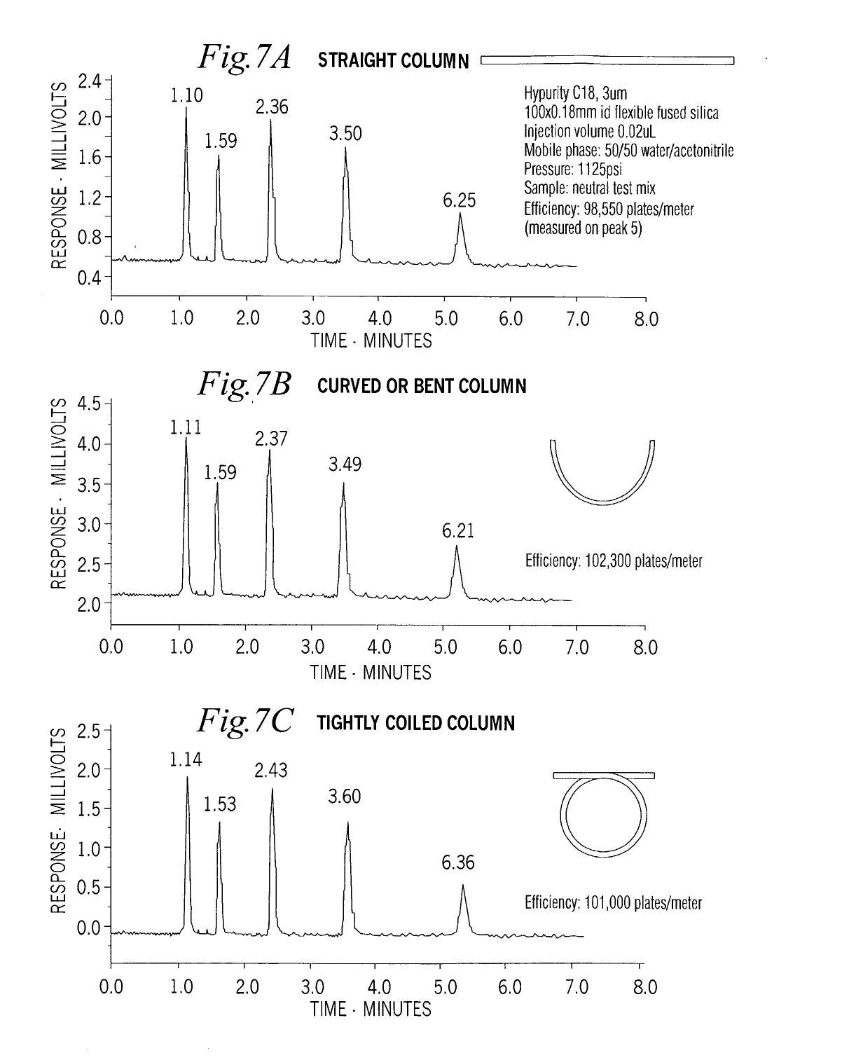

FIG. 7 shows a 100 mm by 0.18 mm column that was tested in a straight, curved and tightly coiled configuration by filling a straight 300 mm by 0.18 mm (inner diameter) fused silica tube, attaching a small section of transparent tubing having a small inner diameter, and measuring the volume change upon bending. In FIG. 7a, the distance between the end-fittings is approximately 100 mm or the entire length of the column bed. In FIG. 7b, the distance between the end-fittings is approximately 45 mm or 45% of the entire length of the column bed and the curve angle is about 50°. In FIG. 7c, the distance between the end-fittings is approximately 30 mm or 30% of the column bed and the coil radius is about 20 mm. No significant volume change within an estimated experimental volumetric measurement error of approximately 0.5% could be observed when the tube was bent to a very tight coil less than 50 mm in diameter. This result demonstrates that the ends of the curved 10 and coiled 16, 17 columns can be advantageously oriented in a variety of positions, thereby enabling convenient installation into a liquid chromatographic system, irrespective of the column bed length.

The columns 10, 16, 17 can be packed in a straight configuration and then bent into the desired shape or they can be packed subsequent to bending. No advantages would seem to accrue from filling a pre-bent column.

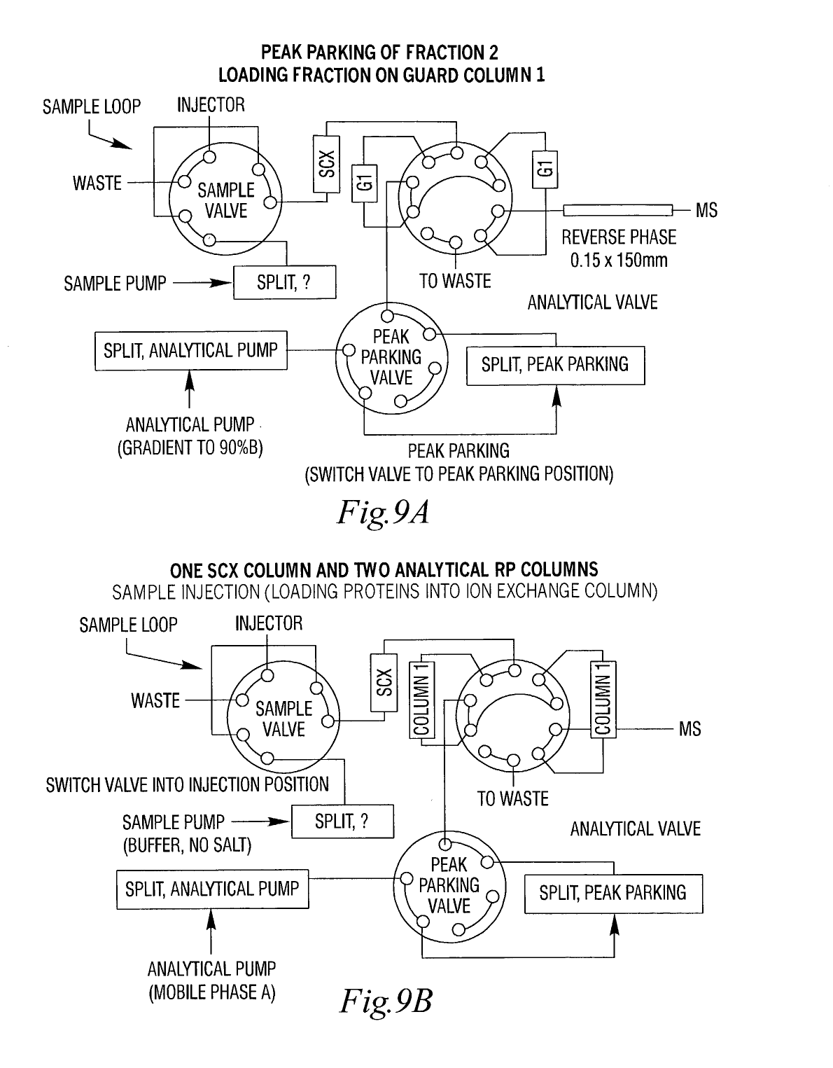

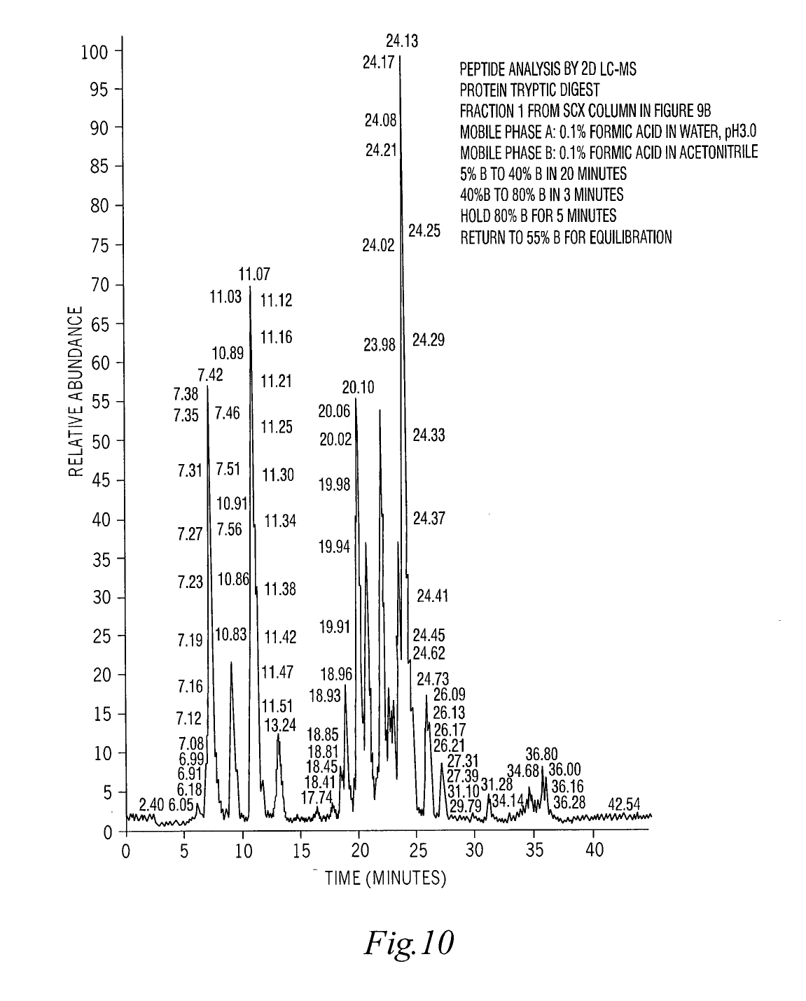

The coiled and curved columns 10, 16, 17 can be employed alone or in connection with a scheme that utilizes multiple columns such as three analytical columns or two analytical columns along with two guard or trap columns (see FIG. 9). Both schemes can produce similar data. For instance, FIG. 9a illustrates how an ion exchange column of analytical dimensions might be used in conjunction with two guard or trap columns, designated G1 and G2, and with a second reversed phase analytical column in a two-dimensional scheme for resolving a protein tryptic digest (FIG. 10). FIG. 9b illustrates a similar, two-dimensional approach that employs three analytical columns and two guard or trap columns. Both schemes can benefit from the present invention because of the convenience and compactness of the coiled 16, 17 and curved columns 10 and also because of the reduction in harmful connection volume that has been unavoidable in the previous designs.

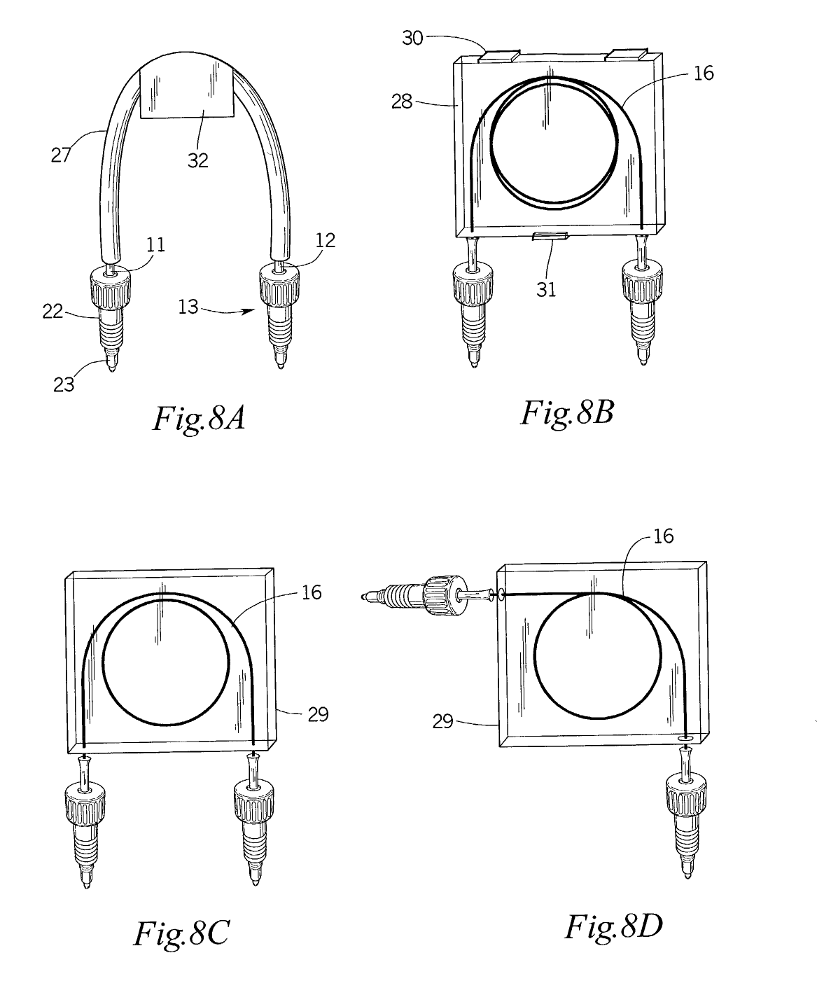

Another embodiment of the present invention includes a housing that advantageously maintains the columns in their curved 10 and coiled 16, 17 positions, and orients the ends 11, 12 of the columns so that convenient installation into a valve assembly 18 (FIG. 5) or other device is achieved. Three forms of this embodiment, comprising a tubular housing 27, an easily removable “base and cover” housing 28 and a single-piece housing 29, are illustrated in FIG. 8. In addition to maintaining the columns 10, 16, 17 in a desired configuration, the housings 27, 28, 29 facilitate easier handling of the columns 10, 16, 17 while simultaneously protecting the columns 10, 16, 17 from damage during such handling and during operation of the liquid chromatographic system.

The shape of the protective housing is not critical to the operability of the invention. It is only important that the housing maintain the first and second ends 11, 12 of the analytical columns 10, 16, 17 at a location that is suitable for direct coupling of the columns to an injector, detector, valve or other manifold, independent of column length. Accordingly, the housing may comprise an angular shape such as a square, a triangle or a rectangle or it may comprise a substantially circular or tubular shape. For ease of manufacturing and ease of handling however, square, circular and tubular shaped housings are generally preferred.

A preferred embodiment of the housing device is illustrated in FIG. 8a. The housing 27 is a curved hollow cylindrical tube having an opening in a first and second end of the tube and having an inner diameter slightly larger than the outer diameter of the curved liquid chromatography column 10, preferably with tight spacing that narrowly permits a fit between the outer surface of the column 10 and the inner surface of the cylindrical tube. The tubular housing 27 can also be molded or otherwise clad around the column 10 to create a completely non-removable, disposable column assembly. The housing 27 can be fabricated in the shape of a coil for use in connection with a coiled analytical column 16, 17. Although the tubing depicted in FIG. 8a comprises an internal cross section having a circular configuration, other configurations, such as squares, may be employed.

The tubular housing 27 extends for substantially the entire length of the curved miniature column 10, but does not normally enclose the first and second ends 11, 12 of the column or the sealing mechanism 13 so that the column 10 can be conveniently installed into the sealing mechanism 13, a valve 18 (FIG. 5), or other fitting manifold and can be easily tightened. The tubular housing 27 maintains the protruding ends 11, 12 of the column in a parallel or near parallel configuration, further facilitating ease of installation.

The housing 27 is desirably fabricated from PEEK or thin wall stainless steel due to the high strengths and low costs of these materials. However, any rigid or semi-rigid plastic or metal material or other material capable of maintaining the desired column configuration may be employed. Preferably, the rigid material further comprises a solvent-resistant material. The same is true of the base and cover 28 and single-piece housings 29 illustrated in FIGS. 8b, 8c and 8d. The present invention differs from the various columns in current use that contain a coating. Here, the column 10 takes the shape of the tubular housing 27 into which it is inserted whereas in the prior art, the coatings take the shape of the columns, which have been essentially straight until now.

An additional embodiment of the housing is illustrated in FIG. 8b. FIG. 8b shows a multiple-coil liquid chromatography column 17 protected by an easily removable base and cover housing 28 wherein the base and cover 28 are coupled together by means of a cooperative hinge 30 and clasp 31 mechanism, forming a hollow space. The housing 28 is relatively flat and the space between the outer surface of the column 17 and inner surfaces of the base and cover 28 is preferably as small as possible so that the column 17 is locked firmly into place upon closing of the assembly 28. A variety of fastening devices may be used in place of the cooperative hinge 30 and clasp 31 mechanism as long as the housing 28 can be opened and closed without great difficulty.

In addition to the multiple-coil column 17, the base and cover housing 28 can also accommodate the curved 10 and single-coil 16 column configurations depicted in FIGS. 1 and 2. Optionally, the housing 28 may be filled with a foam-like material in order to further support the curved 10 and coiled 16, 17 shapes of the columns. The housing 28 desirably comprises a plastic material. However, other rigid and semi-rigid solvent-resistant materials such as metal may be substituted.

The base and cover housing 28 shown in FIG. 8b does not enclose the ends 11, 12 of the column 17 or the column sealing mechanism 13. Rather, the column ends 11, 12 and sealing mechanism 13 advantageously project out of the housing 28 so that installation into a fitting manifold can be achieved. In this embodiment, the ends 11, 12 of the column 17 and the sealing mechanism 13 protrude through the same surface of the housing 28. Also, in this embodiment, the protruding ends 11, 12 are substantially parallel. The column ends 11, 12 and the sealing mechanism 13, however, may protrude through any surface of the housing 28, including adjacent and opposing surfaces, and the ends 11, 12 need not be parallel.

Alternatively, a further embodiment of the invention includes a single-piece housing 29 (FIGS. 8c and 8d) that advantageously eliminates the need for a fastener. The housing 29, comprising a single piece of plastic defining a void cavity, is relatively flat and a space between the exterior surface of the single-coil column 16 and interior surface of the housing 29 is preferably as small as possible so that the single-coil column 16 can be conveniently fitted into the housing 29 and remain fixedly secure.

Alternatively, the housing 29 can be molded or otherwise clad around the column 16 to create a completely non-removable, disposable column assembly. The two near parallel column ends 11, 12 and sealing mechanism 13 project out of an opening in the housing 29, affording access to liquid chromatographic apparatus. Like the base and cover housing shown in FIG. 8b, the single-piece housing 29 can be used in connection with the curved 10 and multiple-coil 17 columns depicted in FIGS. 1 and 3. Further, the column ends 11, 12 and the sealing mechanism 13 may protrude through any surface of the housing 29, including adjacent and opposing surfaces. FIG. 8c shows a single-coil column 16 having ends 11, 12 that protrude through the same surface of the housing 29. The column ends 11, 12 shown in FIG. 8d, however, are oriented at about a 90° angle, and protrude through adjacent surfaces of the housing 29. The single-piece housing 29 can be molded or otherwise fabricated from any rigid or semi-rigid solvent-resistant material including metal.

One advantage to be gained from using a non-tubular housing such as the base and cover housing 28 of FIG. 8b or the single-piece housing 29 depicted in FIG. 8c and 8d, is that a non-tubular housing can be more conveniently constructed to provide added protection from undesirable motion and environmental fluctuations. This is achieved by incorporating environmental control means such as heaters and insulation into removable, non-tubular housings. These devices provide temperature control and permit replacement of air with other fluids.

Each of the housings 27, 28, 29 illustrated in FIGS. 8a, 8b, 8c and 8d may be installed prior to packing a column so that the column can be prepared while in the curved 10 or coiled 16, 17 shape or the column may be packed straight with the housing 27, 28, 29 installed and then bent to the desired shape thereafter. If desired, the housings 27, 28, 29 may be removed after use and reused or they may be disposed of along with the spent columns 10, 16, 17. Housings 27, 28, 29 that are molded in place, however, must be disposed of with the columns 10, 16, 17.

The housings 27, 28, 29 can also be used as an immobilizing device for maintaining the orientation of a curved 10 or a coiled 16, 17 column wound around an external surface of a cylindrical rod or tube. Other immobilizing devices or supports can be used in conjunction with the curved 10 and coiled 16, 17 columns of the present invention.

Yet another advantage of the housing members 27, 28, 29 is that they provide a more suitable surface for labeling a product, manually identifying the use of a column, or color-coding a column, than the current practice of labeling the fragile analytical column itself. FIG. 8a shows a label 32 advantageously affixed to the exterior surface of the tubular housing 27 in order to simplify the task of column identification.

The disclosed curved, single-coil and multiple-coil, packed analytical columns have several advantages over the prior art. The columns facilitate convenient and efficient installation to liquid chromatography apparatus, provide an enhanced “fit” and virtually eliminate the connection volume that degrades performance when capillary column dimensions are employed. The housing devices protect the columns from damage during shipping, handling and use, and may be adapted to provide a controlled environment.

While the invention has been particularly shown and described with reference to preferred embodiments thereof, it will be understood by those skilled in the art that various alterations in form and detail may be made therein without departing from the spirit and scope of the invention.

What is claimed is:

1. A liquid chromatography column comprising a packed miniature analytical column having a first and a second end and having a curved or a coiled configuration.

2. The liquid chromatography column of claim 1, wherein the column further comprises a sealing mechanism disposed over at least one end of the column.

3. The liquid chromatography column of claim 1, wherein the column further comprises a fritted sealing mechanism disposed over at least one end of the column, said fritted sealing mechanism having a filter element integrated therein.

4. The liquid chromatography column of claim 1, wherein the column further comprises an immobilized filter element integrated into at least one end of the column.

5. The liquid chromatography column of claim 1, wherein the column further comprises an immobilized monolithic bed structure.

6. The liquid chromatography column of claim 1, wherein the column comprises a material selected from the group consisting of fused silica, polymer-coated fused silica, polymer-clad fused silica, stainless steel, glass, glass-lined stainless steel, metal and polymer.

7. The liquid chromatography column of claim 1, wherein the column has an inner diameter between approximately 0.05 mm and 2 mm, and a length between approximately 25 mm and 300 mm.

8. The liquid chromatography column of claim 1, wherein the column has an inner diameter between approximately 0.05 mm and 2 mm, and a length between approximately about 25 mm and 5000 mm.

9. The liquid chromatography column of claim 2 further comprising an end-fitting attached to the sealing mechanism.

10. The liquid chromatography column of claim 2 further comprising connector tubing attached to the sealing mechanism.

11. The liquid chromatography column of claim 3 further comprising an end-fitting attached to the fritted sealing mechanism.

12. The liquid chromatography column of claim 3 further comprising connector tubing attached to the fritted sealing mechanism.

13. The liquid chromatography column of claim 1 used in connection with a total solution liquid chromatographic system.

14. A device for use in a liquid chromatographic system, comprising a packed miniature analytical column having a first and a second end, and having a housing that encases at least a portion of the column, said column having a curved or a coiled configuration, wherein the housing maintains the curved or coiled configuration of the column and maintains the ends of the column at fixed locations.

15. The device of claim 14, wherein the column further comprises a sealing mechanism disposed over at least one end of the column.

16. The device of claim 14, wherein the column further comprises a fritted sealing mechanism disposed over at least one end of the column, said fritted sealing mechanism having a filter element integrated therein.

17. The device of claim 14, wherein the column further comprises an immobilized filter element integrated into at least one end of the column.

18. The device of claim 14, wherein the column further comprises an immobilized monolithic bed structure.

19. The device of claim 14, wherein the column comprises a material selected from the group consisting of fused silica, polymer-coated fused silica, polymer-clad fused silica, stainless steel, glass, glass-lined stainless steel, metal and polymer.

20. The device of claim 14, wherein the column has an inner diameter between approximately 0.05 mm and 2 mm, and a length between approximately 25 mm and 300 mm.

21. The device of claim 14, wherein the column has an inner diameter between approximately 0.05 mm and 2 mm, and a length between approximately about 25 mm and 5000 mm.

22. The device of claim 15 further comprising an end-fitting attached to the sealing mechanism.

23. The device of claim 15 further comprising connector tubing attached to the sealing mechanism.

24. The device of claim 16 further comprising an end-fitting attached to the fritted sealing mechanism.

25. The device of claim 16 further comprising connector tubing attached to the fritted sealing mechanism.

26. The device of claim 14 used in connection with a total solution liquid chromatographic system.

27. The device of claim 14, wherein the housing comprises a substantially tubular configuration, the internal diameter of said tubular housing being slightly larger than an outer diameter of the column.

28. The device of claim 14, wherein the housing comprises a substantially flat top member and an opposed substantially flat bottom member, said members defining a space to receive and fixedly secure the column there between, said housing being separable from the column.

29. The device of claim 14, wherein the housing is molded or clad onto an external surface of the column.

30. The device of claim 14, wherein the housing comprises a rigid or semi-rigid material

31. The device of claim 14, wherein the rigid material comprises a plastic or a metal.

32. The device of claim 28, wherein the housing further comprises an environmental control means located in said space between said top and bottom housing members.

33. A sealing sleeve for use with a packed miniature liquid chromatography column, comprising a substantially hollow cylindrical tube having a first end and a second end, and a filter element integrated into one end of the cylindrical tube.

34. A device for use in a liquid chromatographic system, comprising a packed miniature curved or coiled analytical column having a first and a second end, and having an immobilizing means that maintains the curved or coiled configuration of the column and maintains the ends of the column at fixed locations, wherein the column is wound around an external surface of a cylindrical rod.

35. The device of claim 34, wherein the immobilizing means comprises a housing.
